(19) United States
(12) Patent Application Publication
(10) Pub. No.: US 2025/0162416 A1
(43) Pub. Date: May 22, 2025

(54) AVNT SYSTEM FOR VEHICLE AND METHOD FOR CONTROLLING THE SAME AND VEHICLE INCLUDING THE SAME

(71) Applicants: Hyundai Motor Company, Seoul (KR); Kia Corporation, Seoul (KR)

(72) Inventors: Hyun Woo LEE, Hwaseong-Si (KR); Young Woo PARK, Hwaseong-Si (KR)

(73) Assignees: Hyundai Motor Company, Seoul (KR); Kia Corporation, Seoul (KR)

(21) Appl. No.: 18/949,793

(22) Filed: Nov. 15, 2024

(30) Foreign Application Priority Data
Nov. 21, 2023 (KR) 10-2023-0162182

(51) Int. Cl. B60K 35/28; B60K 35/80

(52) U.S. Cl. CPC B60K 35/28; B60K 35/80; B60K 2360/11; B60K 2360/563; B60K 2360/5911

(57) ABSTRACT

An Audio Video Navigation Telematics (AVNT) system for vehicles include a display unit configured to display home screen menus including function menus for the AVNT and a processor configured to control the display unit. When a call channel of a smartphone is connected to the AVNT through Bluetooth, the processor is configured to determine a call state through the smartphone: an outgoing call state, an incoming call state, and an active call state, may check a first information on a phone number using a first command value in the determined call state, may analyze a second information checked with the phone number using the checked first information and a second command value, and may be configured for controlling the display unit to display a first state or a second state different from the first state based on the analysis results.

### CROSS-REFERENCE TO RELATED APPLICATIONS

The present application claims priority to Korean Patent Application No. 10-2023-0162182, filed on Nov. 21, 2023, the entire contents of which is incorporated herein for all purposes by this reference.

### BACKGROUND OF THE PRESENT DISCLOSURE

### Field of the Present Disclosure

The present disclosure relates to an Audio Video Navigation Telematics (AVNT) system for vehicles, and more particularly, to an AVNT system for vehicles, which is configured for determining whether a poor call has been caused by an issue regarding a smartphone app of a user and the like and accurately identifying the cause of the problem, a method for controlling the system, and a vehicle including the system.

### Description of Related Art

The statements in the present section merely provide background information related to the present disclosure and may not form related art.

In general, an AVNT system for vehicles provides various conveniences to vehicle occupants by integrating electronic devices, such as an audio device, a video device, a navigation device, and a telematics device, which are mounted on a vehicle.

Accordingly, the AVNT system for vehicles integrates multiple electronic devices and includes diverse functions and menus. For example, when a smartphone is connected to the AVNT system for vehicles, the smartphone operates for a Bluetooth hands-free call through a microphone input through the vehicle AVNT system.

Here, when the input microphone is required for purposes other than a hands-free call, the smartphone opens a call channel even though it is not busy, and the vehicle AVNT system turns busy. Examples of such a situation include the voice recognition operation of a smartphone, a voice call on the Kakao Talk messenger, a voice call on a messenger app, a video conference, a voice chat on a game site, etc.

For the voice recognition operation of smartphones, there are the specifications of AT+BVRA and +BVRA, set by the Bluetooth SIG, but, for the rest of the operations, 3rd party apps arbitrarily use features for hands-free calls and often do not even handle the general event of receiving/accepting/terminating calls. This is because there is little compulsion between smartphones and the OS app.

As a result, users often perceive unknown call events or errors caused by smartphone apps as a defect in the AVNT system for vehicles and contact vehicle customer service centers.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an AVNT system for vehicles configured for accurately perceiving unknown call events or errors caused by smartphone apps, a method for controlling the system, and a vehicle including the system.

The technological problems to be solved through the present disclosure are not limited to those mentioned above, and the following description would enable a person having ordinary skill in the art to clearly understand other technological problems not mentioned above.

To resolve the technological problems mentioned above, the AVNT system for vehicles according to an exemplary embodiment of the present disclosure may include a display unit configured to display function menus for the AVNT and a processor operatively connected to the AVNT and configured to control the display unit, wherein, when a user's terminal is connected to the AVNT through Bluetooth, the processor is further configured to determine a call state through the user's terminal, the call state including an outgoing call state, an incoming call state, and an active call state, check a first information on a phone number using a first command value in the determined call state, analyze a second information checked with the phone number using the checked first information and a second command value, and control the display unit to display a first state or a second state different from the first state based on a result of the analysis.

When it is determined that both the first information and the second information satisfy preset conditions, the processor may allow the first state to be displayed on the display unit.

When it is determined that at least one of the first information and the second information does not meet the preset conditions, the processor may allow the second state to be displayed on the display unit.

When the call state cannot be determined, the processor may analyze the second information checked with the phone number using the second command value, and display the first state or the second state on the display unit based.

When the first information cannot be checked, the processor may analyze the second information checked with the phone number using the second command value, and may display the first state or the second state on the display unit.

When it is determined that the phone number is consistent with a third command value, it may allow the second state to be displayed on the display unit.

When it is determined that the phone number is inconsistent with the third command value, the processor may search for the phone number on the user's terminal, and the processor may allow the first state to be displayed on the display unit in response to the phone number being searched out on the user's terminal.

When it is determined that the phone number is failed to be searched out on the user's terminal, the processor is configured to determine whether the phone number is available based on a country in a current Global Positioning System (GPS) location.

When it is determined that the phone number is impossible and within a preset false range, the processor may allow the second state to be displayed on the display unit.

The processor may further configured to allow the first state to be displayed on the display unit when it is determined that the phone number is possible and valid, and to allow the second state to be displayed on the display unit when it is determined that the phone number is possible and invalid.

Furthermore, an exemplary embodiment of the present disclosure may provide a method for controlling an AVNT system for a vehicle including a display unit configured to display function menus for the AVNT and a processor operatively connected to the AVNT and configured to control the display unit, wherein, the method includes, when a user's terminal is connected to the AVNT through Bluetooth, determining a call state through the smartphone, the call state including an outgoing call state, an incoming call state, and an active call state, checking a first information on a phone number using a first command value in the determined call state, analyzing a second information checked with the phone number using the checked first information and a second command value, and controlling the display unit to display a first state or a second state different from the first state based on a result of the analyzing.

Under the control of the processor, when both the first information and the second information are determined to satisfy preset conditions based on analysis results, the first state may be displayed on the display unit.

The controlling of the display unit may include displaying the second state on the display unit when at least one of the first information and the second information is not determined to meet the preset conditions.

The method may further include, when the call state is not determined, analyzing the second information checked with the phone number using the second command value, and controlling the display unit to display the first state or the second state based on a result of the analyzing.

The method may further include, when the first information is not checked, analyzing the second information checked with the phone number using the second command value, and controlling the display unit to display the first state or the second state based on a result of the analyzing.

The method may further include, when it is determined that the phone number is consistent with a third command value, displaying the second state on the display unit.

The method may further include, when it is determined that the phone number is not consistent with the third command value, searching the user's terminal for the phone number, and displaying the first state on the display unit in response to the phone number being searched out on the user's terminal.

The method may further include, when it is determined that the phone number is failed to be searched out on the user's terminal, determining whether the phone number is available based on a country in a current Global Positioning System (GPS) location.

The method may further include, when it is determined that the phone number is impossible and within a preset false range, displaying the second state on the display unit.

The method may further include displaying the first state on the display unit when it is determined that the phone number is possible and valid, and determining displaying the second state on the display unit when it is determined that the phone number is possible and invalid.

A vehicle according to an exemplary embodiment of the present disclosure may include an AVNT system for vehicles including a display unit configured to display home screen menus including function menus for AVNT and a processor configured to control the display unit. Under the control of the processor, when a call channel of a smartphone is connected to the AVNT through Bluetooth, the AVNT system for vehicles may be configured to determine a call state through the smartphone: an outgoing call state, an incoming call state, and an active call state, may check a first information on a phone number using a first command value in the determined call state, may analyze a second information checked with the phone number using the checked first information and a second command value, and may be configured for controlling the display unit to display a first state or a second state different from the first state based on the analysis results.

Through the AVNT system for vehicles, the method for controlling the system, and the vehicle including the system, according to at least an exemplary embodiment of the present disclosure as described above, it may be possible to accurately perceive unknown call events or errors caused by smartphone apps through the AVNT system for vehicles, significantly reducing inconvenience experienced by users.

Furthermore, through the AVNT system for vehicles, the method for controlling the system, and the vehicle including the system, according to at least an exemplary embodiment of the present disclosure, it may be possible to enable users to accurately perceive unknown call events or errors caused by smartphone apps through the AVNT system for vehicles, improving vehicle reliability.

The effects of the present disclosure are not limited to those mentioned above, and the following description would enable a person including ordinary skill in the art to clearly understand other effects thereof not mentioned above.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram for illustrating components of an AVNT system for vehicles according to an exemplary embodiment of the present disclosure.

FIG. 2 and FIG. 3 are flowcharts for illustrating a method for controlling the AVNT system for vehicles according to an exemplary embodiment of the present disclosure.

FIG. 4A, FIG. 4B and FIG. 4C are views for illustrating what is displayed on a display unit according to an exemplary embodiment of the present disclosure.

FIG. 5 is a view for illustrating the results of making decisions through operation of a processor according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, predetermined dimensions, orientations, locations, and shapes, will be determined in portion by the particularly intended application and use environment.

In the figures, the same reference numerals refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, with reference to the appended drawings, the exemplary embodiments of the present disclosure will be described in detail to allow a person having ordinary skill in the art to easily carry out them. However, the present disclosure may be conducted in various forms, and is not limited to the exemplary embodiments described herein. Furthermore, to clearly describe the present disclosure, parts not related to the description have been omitted from the drawings, and similar drawing reference numerals have been provided to similar parts throughout the present disclosure.

Throughout the present disclosure, when a certain part is described to “include” a certain component, it does not mean that the part excludes the other components, but means that the part may further include the other components, unless specifically stated to the contrary. Furthermore, terms such as “unit,” “part,” and “module” used in an exemplary embodiment of the present disclosure refer to a unit of processing at least one function or operation, which may be in a form of hardware, software, or a combination thereof.

Throughout the present disclosure, when a certain part is described to “include” a certain component, it does not mean that the part excludes the other components, but means that the part may further include the other components, unless specifically stated to the contrary. Furthermore, throughout the present disclosure, parts provided the same reference numbers refer to the same components.

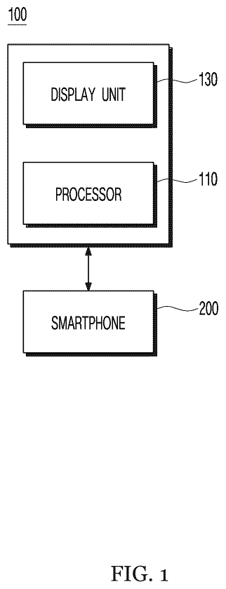

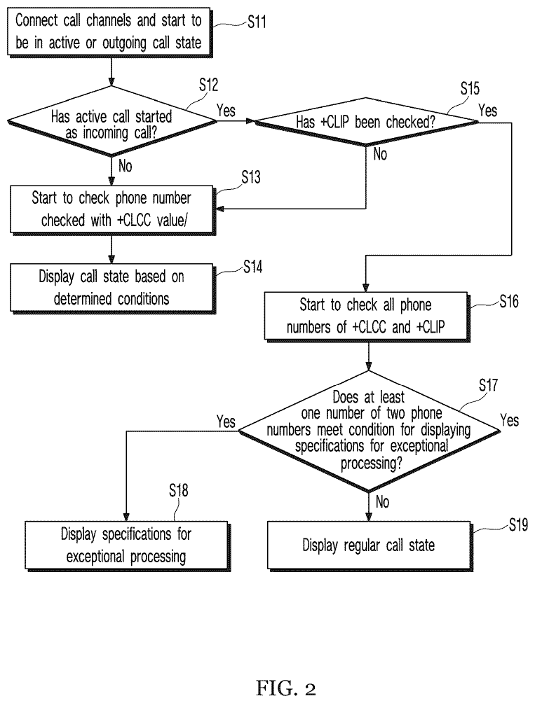

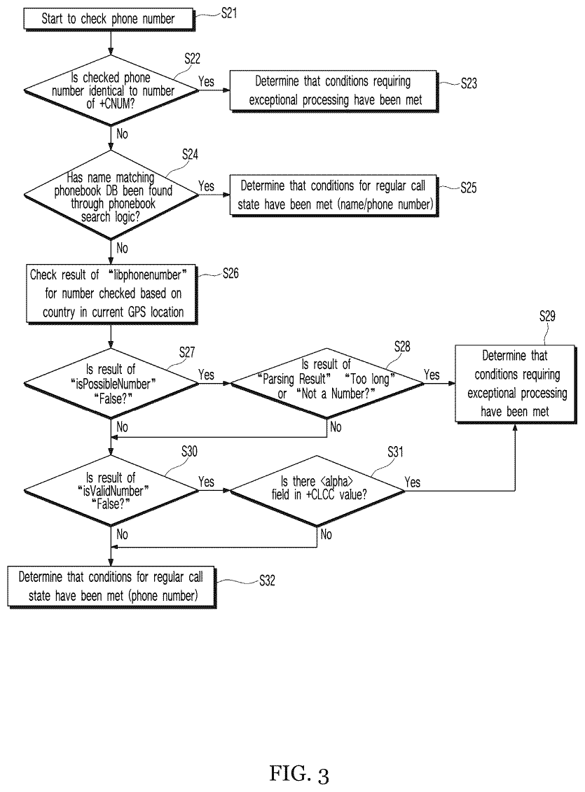

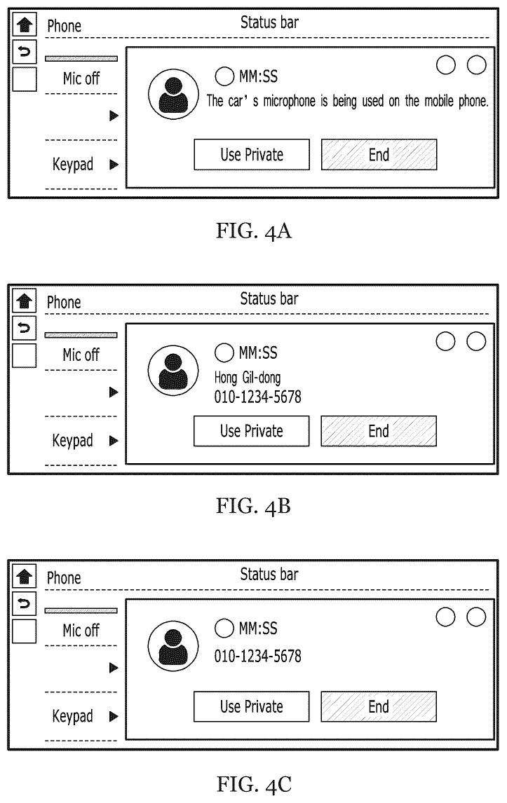

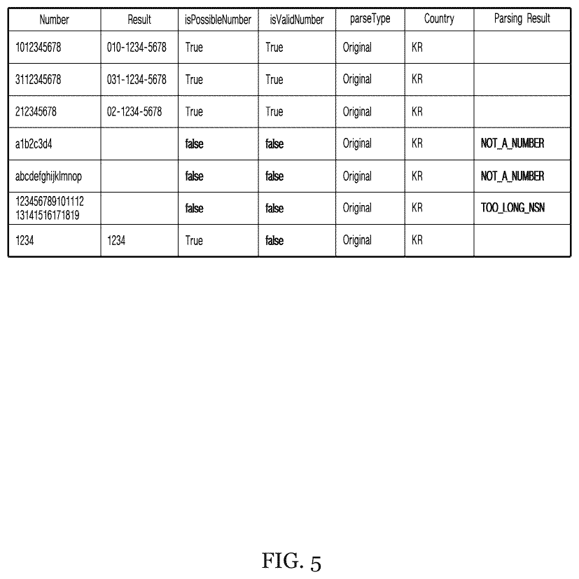

Hereinafter, an AVNT system for vehicles, a method for controlling the same, and a vehicle including the same according to the exemplary embodiments of the present disclosure will be described in detail with reference to FIG. 1, FIG. 2, FIG. 3, FIG. 4A, FIG. 4B and FIG. 4C, and FIG. 5.

Here, an AVNT system for vehicles 100 according to an exemplary embodiment of the present disclosure may also be referred to as a head unit (H/U).

FIG. 1 is a block diagram for describing components of the AVNT system for vehicles according to an exemplary embodiment of the present disclosure.

As shown in FIG. 1, the AVNT system for vehicles 100 according to an exemplary embodiment of the present disclosure may include a display unit 130 for displaying home screen menus including a number of Audio Video Navigation Telematics (AVNT) function menus and a processor 110 for controlling the display unit 130.

Under the control of the processor 110, the display unit 130 may set AVNT function menus as home screen menus and display the set home screen menus.

For example, a number of AVNT function menus may include at least one of a phone menu, a driving information menu, a phone projection menu, a radio menu, a media menu, a USB video menu, a map menu, a navigation menu, a settings menu, a favorites menu, a voice memo menu, a DMB menu, and a message menu, but are not limited thereto.

The display unit 130 may display a first state or a second state different from the first state under the control of the processor 110.

Here, the first state may be a state where a call made to a smartphone 200 is available through Bluetooth. In the first state, the processor 110 may display a phone number and a name or a phone number on the display unit 130. In contrast, the second state may be a state where the call made to the smartphone is not available through Bluetooth. In the second state, the processor 110 may display a message of the reason why the call is unavailable, instead of a phone number and a name or a phone number, on the display unit 130. A detailed description thereof will be provided below.

The processor 110 may be configured for controlling the display unit 130. When a call channel of the smartphone 200 is connected to the AVNT through Bluetooth, the processor 110 may be configured to determine a call state through the smartphone 200: an outgoing call state, an incoming call state, and an active call state, may check a first information on a phone number using a first command value in the determined call state, and may analyze a second information checked with the phone number using the checked first information and a second command value. Here, the smartphone 200 may be referred to as a mobile phone.

The first command value may be one of AT commands and may be +CLIP. The +CLIP may mainly provide information on the ringing state of an incoming call in a hands-free profile (HFP). For example, the first command value may provide information on RING (ALERT) and the related call, and the information on the related call may include the phone number.

The second command value may be one of the AT commands and may be +CLCC. The +CLCC may receive the results of querying information on the status of the current call made on a smartphone, a phone number, etc.

The processor 110 may be configured for controlling the display unit 130 to display the first state or the second state different from the first state based on analysis results. A detailed description thereof will be provided below.

FIG. 2 and FIG. 3 are flowcharts for describing a method for controlling the AVNT system for vehicles according to an exemplary embodiment of the present disclosure. FIG. 4A, FIG. 4B, and FIG. 4C are views for describing what is displayed on the display unit according to an exemplary embodiment of the present disclosure. FIG. 5 is a view for describing the results of making decisions through operation of the processor according to an exemplary embodiment of the present disclosure.

Referring to FIG. 2, FIG. 3, FIG. 4A, FIG. 4B, FIG. 4C and FIG. 5, the method for controlling the AVNT system for vehicles according to an exemplary embodiment of the present disclosure is as follows.

As shown in FIG. 2, the AVNT system for vehicles according to an exemplary embodiment of the present disclosure may connect a smartphone and the AVNT through Bluetooth under the control of the processor. When the smartphone and the AVNT are connected through call channels, the processor is configured for controlling them to be in the active or outgoing call state at S11. Here, the connection through the call channels may mean that the channels through which a calling voice is actually transmitted are connected to each other.

Here, when the call channels of the smartphone and the AVNT are connected through Bluetooth, they may be in an HFP state. There may be basic call states in the HFP state: the incoming call state, the outgoing call state, and the active call state.

For example, the call state may be switched from the incoming call state to the active call state, or from the outgoing call state to the active call state, under the control of the processor, and may be immediately switched to the active call state in some situations.

That is, when a call channel of the smartphone 200 is connected to the AVNT through Bluetooth, the processor 110 may be configured to determine the call state through the smartphone 200: the outgoing call state, the incoming call state, and the active call state at S12. For example, the processor 110 may be configured to determine whether an active call has started as an incoming call.

The process 110 may check the first information on a phone number using the first command value in a determined call state at S15. Here, the first command value may be one of the AT commands and may be the +CLIP. The +CLIP may mainly provide information on the ringing state of an incoming call in the HFP. For example, the first command value may provide first information which is information on RING (ALERT) and the related call, and the first information may include the phone number. That is, the processor 110 may proceed with the process of checking a phone number through the +CLIP.

Thereafter, the process 110 may analyze the second information checked with the phone number using the checked first information and the second command value at S16. Here, the second command value may be one of the AT commands and may be the +CLCC. The +CLCC may receive the results of querying information on the state of the current call made on the smartphone 200, a phone number, etc. In the instant case, the information on the state of the current call made on the smartphone 200, a phone number, etc. may be the second information.

For example, the processor 110 may proceed with the process of checking all phone numbers of the +CLCC and the +CLIP. Because some smartphone apps transmit the phone numbers of the +CLCC and the +CLIP differently, additional checking may be performed when there is the +CLIP.

Accordingly, at S18 and S19, the processor 110 may be configured for controlling the display unit 130 to display the first state or the second state different from the first state based on analysis results (S17).

When determining that both the first information and the second information satisfy preset conditions based on analysis results at S17, the processor 110 may allow the first state to be displayed on the display unit 130 at S19. For example, when the first information and the second information include an available phone number, the processor 110 may not determine that there is a condition for displaying specifications for exceptional processing and may allow the first state to be displayed on the display unit 130. Here, the first state may be a regular call state. In the first state, under the control of the processor 110, a name and a phone number or a phone number may be displayed on the display unit 130, as shown in FIG. 4B or FIG. 4C.

In contrast, when determining that at least one of the first information and the second information does not meet the preset conditions based on analysis results at S17, the processor 110 may allow the second state to be displayed on the display unit 130 at S18. For example, when the first information and the second information include at least one unavailable phone number, the processor 110 may be configured to determine that there is a condition for displaying specifications for exceptional processing and may allow the second state to be displayed on the display unit 130. Here, the second state may be a state of specifications for exceptional processing. In the second state, under the control of the processor 110, specifications for exceptional processing may be displayed on the display unit 130, as shown in figure FIG. 4A. For example, the specifications for exceptional processing may include a message of the reason why a call is unavailable instead of a phone number and a name or a phone number. For example, the display unit 130 may display the specifications for exceptional processing saying “The car's microphone is being used on the mobile phone.” It is not limited thereto.

Furthermore, when a call state cannot be determined at S12, the processor 110 may analyze the second information checked with a phone number using the second command value at S13. For example, the processor 110 may proceed with the process of checking a phone number checked with a +CLCC value.

Thereafter, the processor 110 may display the first state or the second state on the display unit 130 based on analysis results at S14. The first state may be different from the second state.

Furthermore, when the first information cannot be checked at S15, the processor 110 may analyze the second information checked with a phone number using the second command value at S13. For example, the processor 110 may proceed with the process of checking a phone number checked with a +CLCC value.

Thereafter, the processor 110 may display the first state or the second state on the display unit 130 based on analysis results at S14.

Referring to FIG. 3, according to an exemplary embodiment of the present disclosure, the processor 110 may be configured for controlling the process of checking a phone number using the first command value, the second command value, and the third command value.

As described above in connection with FIG. 2, the processor 110 may be configured for controlling the process of checking a phone number using the first command value and/or the second command value at S21.

The processor 110 may compare a phone number with the third command value to determine whether the phone number is consistent with the third command value at S22. Here, the third command value may be +CNUM. The +CNUM may be a message for checking a phone number of the smartphone 200 currently connected to the AVNT through Bluetooth. For example, the processor 110 may be configured to determine whether the checked phone number is consistent with a number of the +CNUM.

When the processor 110 compares a phone number with the third command value and determines that the phone number is consistent with the third command value at S22, it may be configured for controlling the second state to be displayed on the display unit 130 at S23. For example, when the voice recognition operation of the smartphone 200 is conducted, the phone number is consistent with the third command value. In general, when the voice recognition operation of the smartphone 200 is conducted, a call is made to a user's own phone number.

Accordingly, the processor 110 may display conditions requiring exceptional processing on the display unit 130, as shown in figure FIG. 4A, at S23. For example, the conditions requiring exceptional processing or the specifications for exceptional processing may include a message of the reason why a call is unavailable instead of a phone number and a name or a phone number. For example, the display unit 130 may display the conditions requiring exceptional processing or the specifications for exceptional processing, saying “The car's microphone is being used on the mobile phone.” It is not limited thereto.

In contrast, when the processor 110 compares a phone number with the third command value and does not determine that the phone number is consistent with the third command value at S22, it may search for the phone number on the smartphone 200 or may download phone numbers stored in the smartphone 200 to search for the phone number at S24.

When a phone number matching the phone number is found as a result of the searching at S24, the processor 110 may be configured for controlling the first state to be displayed on the display unit 130 at S25. Here, the processor 110 may download the phone numbers stored in the smartphone 200 in advance through the phone book access profile (PBAP) connection. For example, the phone book may be downloaded in advance through the PBAP connection after the smartphone has been connected. For example, the processor 110 may be configured to determine whether a name matching the phonebook DB has been found through a phonebook search logic.

That is, the processor 110 may be configured for controlling the first state to be displayed on the display unit 130 when a name matching the phonebook DB has been found through the phonebook search logic. Here, the first state may be a regular call state. In the first state, under the control of the processor 110, the matching name and a corresponding phone number may be displayed on the display unit 130, as shown in figure FIG. 4B.

Furthermore, when the processor 110 has searched for a phone number on the smartphone 200 and failed to find a phone number matching the phone number at S24, it may determine whether the phone number is available based on a country in the current GPS location at S26. For example, the processor 110 may check the result of “libphonenumber” for the number checked based on the country in the current GPS location. Here, the “libphonenumber” requires country information to be input in addition to a phone number, so the current country information may be received and used through the GPS of a vehicle. A detailed description thereof will be provided below.

Furthermore, when the processor 110 determines that a phone number is impossible at S27 and is within a preset false range at S28, it may display the second state on the display unit 130 at S29. For example, when the result of “isPossibleNumber” is “False” at S27 and the result of “Parsing Result” is “Too long” or “Not a Number,” the processor 110 may display conditions requiring exceptional processing on the display unit 130, as shown in figure FIG. 4A, at S29. Here, because, in an actual call network, only numbers with a length that meets a national phone number standard may be checked and texts may not be included, the exceptional processing may be required only when the result of the “isPossiblenumber” of the “libphonenumber” is “Too Long” or “Not a number.”

In contrast, when the processor 110 does not determine that a phone number is possible at S27 and is within the preset false range at S28, it may determine whether the checked number is valid at S30. For example, when, when the result of the “isPossibleNumber” is “False” at S27 and the result of the Parsing Result is not “Too long” or “Not a Number,” the processor 110 may be configured to determine whether the checked number corresponds to “isValidNumber.”

Furthermore, when the processor 110 determines that a phone number is possible at S27 and valid at S30, it may display the first state on the display unit 130 at S32. For example, when the result of the “isPossibleNumber” is not “False” at S27 and the result of the “isValidNumber” is not “False,” the processor 110 may display the phone number in a regular call state on the display unit 130, as shown in figure FIG. 4C, at S32.

Furthermore, when the processor 110 determines that a phone number is possible at S27 but is not valid at S30, it may be configured to determine whether there is an <alpha> field in the +CLCC value at S31. For example, when there is the <alpha> field in the +CLCC value, the processor 110 may display the second state on the display unit 130 at S29.

In contrast, when there is not the <alpha> field in the +CLCC value, the processor 110 may display the first state on the display unit 130 at S32.

As described above, the reason why both the of whether “isValidnumber” is false at S30 and whether there is the <alpha> field in the +CLCC value at S31 are checked together is because certain apps on the smartphone 200 may start calling with numbers that are actually unavailable but are not that long. Here, the apps on the smartphone 200 may transmit the app names and the like to the <alpha> field in the +CLCC value.

Referring to FIG. 5, the processor 110 may be configured to determine that the numbers 1012345678, 3112345678, and 212345678 are 010-1234-5678, 031-1234-5678, and 02-1234-5678, respectively. Accordingly, the processor 110 may be configured to determine that the results of the “isPossibleNumber” and the “isValidnumber” are “True,” and may be configured to determine that “parseType” is “Original” and the country is KR.

Contrariwise, in the case of the numbers a1b2c3d4 and abcdefghijklmnop, the processor 110 may be configured to determine that the results of both the “isPossibleNumber” and the “is Validnumber” are “False,” and may be configured to determine that the “parseType” is “Original” and the country is KR. However, the processor 110 may be configured to determine that “Parsing Result” is “NOT A NUMBER.”

Furthermore, in the case of the number 12345678910111213141516171819, the processor 110 may be configured to determine that the results of both the “isPossibleNumber” and the “is Validnumber” are “False,” and may be configured to determine that the “parseType” is “Original” and the country is KR. However, the processor 110 may be configured to determine that the “Parsing Result” is “TOO LONG NSN.”

Furthermore, in the case of the number 1234, the processor 110 may be configured to determine that it is 1234. However, the processor 110 may be configured to determine that the result of the “isPossibleNumber” is “True” and the result of “isValidnumber” is “False,” and may be configured to determine that the “parseType” is “Original” and the country is KR.

As described above, according to an exemplary embodiment of the present disclosure, it may be possible to accurately perceive unknown call events or errors caused by smartphone apps through the AVNT system for vehicles, significantly reducing inconvenience experienced by users.

Furthermore, according to an exemplary embodiment of the present disclosure, it may be possible to enable users to accurately perceive unknown call events or errors caused by smartphone apps through the AVNT system for vehicles, improving vehicle reliability.

The present disclosure, which has been described above, may be conducted as a computer-readable code on a program-recorded medium. Examples of a computer-readable medium include all types of recording devices that store data which may be read by a computer system, such as a Hard Disk Drive (HDD), a solid-state disk (SSD), a silicon disk drive (SDD), a ROM, a RAM, a CD-ROM, a magnetic tape, a floppy disk, and an optical data non-transitory storage device.

Accordingly, the detailed description should not be construed as restrictive in any respect but as illustrative. The scope of the present disclosure should be determined based on reasonable interpretation of the appended claims, and all changes within the scope of the present disclosure are included in the scope thereof.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be

understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An Audio Video Navigation Telematics (AVNT) system for a vehicle, the AVNT system comprising
a display unit configured to display function menus for the AVNT; and
a processor operatively connected to the AVNT and configured to control the display unit,
wherein, in response that a user's terminal is connected to the AVNT through Bluetooth, the processor is further configured to:
determine a call state through the user's terminal, the call state including an outgoing call state, an incoming call state, and an active call state;
check a first information on a phone number using a first command value in the determined call state;
analyze a second information checked with the phone number using the checked first information and a second command value; and
control the display unit to display a first state or a second state different from the first state based on a result of the analysis.

2. The system of claim 1, wherein, upon concluding that both the first information and the second information satisfy preset conditions, the processor allows the first state to be displayed on the display unit.

3. The system of claim 2, wherein, upon concluding that at least one of the first information and the second information does not meet the preset conditions, the processor allows the second state to be displayed on the display unit.

4. The system of claim 1, wherein, in response that the call state cannot be determined by the processor, the processor is further configured to analyze the second information checked with the phone number using the second command value, and display the first state or the second state on the display unit based.

5. The system of claim 1, wherein, in response that the first information cannot be checked by the processor, the processor is further configured to analyze the second information checked with the phone number using the second command value, and display the first state or the second state on the display unit.

6. The system of claim 1, wherein, upon concluding that the phone number is consistent with a third command value, the processor is further configured to allow the second state to be displayed on the display unit.

7. The system of claim 6, wherein, upon concluding that the phone number is inconsistent with the third command value, the processor is further configured to search for the phone number on the user's terminal, and allow the first state to be displayed on the display unit in response to the phone number being searched out on the user's terminal.

8. The system of claim 7, wherein, upon concluding that the phone number is failed to be searched out on the user's terminal, the processor is further configured to determine whether the phone number is available based on a country in a current Global Positioning System (GPS) location.

9. The system of claim 8, wherein, upon concluding that the phone number is impossible and within a preset false range, the processor is further configured to allow the second state to be displayed on the display unit.

10. The system of claim 9, wherein the processor is further configured to allow the first state to be displayed on the display unit, upon concluding that the phone number is possible and valid, and to allow the second state to be displayed on the display unit, upon concluding that the phone number is possible and invalid.

11. A method for controlling an Audio Video Navigation Telematics (AVNT) system for a vehicle including a display unit configured to display function menus for the AVNT and a processor operatively connected to the AVNT and configured to control the display unit, the method comprising:
in response that a user's terminal is connected to the AVNT through Bluetooth, determining, by the processor, a call state through a smartphone, the call state including an outgoing call state, an incoming call state, and an active call state;
checking, by the processor, a first information on a phone number using a first command value in the determined call state;
analyzing, by the processor, a second information checked with the phone number using the checked first information and a second command value; and
controlling, by the processor, the display unit to display a first state or a second state different from the first state based on a result of the analyzing.

12. The method of claim 11, wherein, under the control of the processor, in response that the processor concludes both the first information and the second information satisfy preset conditions based on analysis results, the first state is displayed on the display unit.

13. The method of claim 12, wherein the controlling of the display unit includes displaying the second state on the display unit in response that the processor concludes at least one of the first information and the second information does not meet the preset conditions.

14. The method of claim 11, further including, in response that the call state is not determined, analyzing, by the processor, the second information checked with the phone number using the second command value, and controlling, by the processor, the display unit to display the first state or the second state based on a result of the analyzing.

15. The method of claim 11, further including, in response that the first information is not checked, analyzing, by the processor, the second information checked with the phone number using the second command value, and controlling, by the processor, the display unit to display the first state or the second state based on a result of the analyzing.

16. The method of claim 11, further including, in response that the processor concludes that the phone number is consistent with a third command value, displaying, by the processor, the second state on the display unit.

17. The method of claim 16, further including, in response that the processor concludes that the phone number is not consistent with the third command value, searching, by the processor, the user's terminal for the phone number, and displaying, by the processor, the first state on the display unit in response to the phone number being searched out on the user's terminal.

18. The method of claim 17, further including, in response that the processor concludes that the phone number is failed to be searched out on the user's terminal, determining, by the processor, whether the phone number is available based on a country in a current Global Positioning System (GPS) location.

19. The method of claim 18, further including, in response that the processor concludes that the phone number is impossible and within a preset false range, displaying, by the processor, the second state on the display unit.

20. The method of claim 19, further including displaying, by the processor, the first state on the display unit in response that the processor concludes that the phone number is possible and valid, and displaying, by the processor, the second state on the display unit in response that the processor concludes that the phone number is possible and invalid.
